(19) United States
(12) Patent Application Publication
(10) Pub. No.: US 2006/0126352 A1
(43) Pub. Date: Jun. 15, 2006

(54) Illuminated exterior decorative device

(76) Inventor: Young Chul Kwon, Granada Hills, CA (US)

Correspondence Address: PARK LAW FIRM, 3255 WILSHIRE BLVD, SUITE 1110, LOS ANGELES, CA, 90010, US

(21) Appl. No.: 11/009,604

(22) Filed: Dec. 10, 2004

(51) Int. Cl. B60Q 1/26

(52) U.S. Cl. 362/540; 362/545; 362/230; 362/231; 362/183

(57) ABSTRACT

An illuminated exterior decorative device for vehicles includes a decorative part for a vehicle trademark like an emblem, an illuminating part illuminating the decorative part at least partially, and a mounting part attaching the illuminated exterior decorative device to the vehicles. The decorative part comprises a combination of an optically opaque part and an optically transmissive part. The optically transmissive part has a predetermined color. The illuminating part includes a light source and a light diffusion part. The light source includes one or more regular electric lamp or some other source such as light-emitting-diode. The illuminating part can include a controller to control the color, luminance, and duration of the illumination. The mounting part includes a double-sided adhesive tape, mechanical fastener, or one or more magnets. The illuminating part may include a fluorescent substance and a material with phosphorescence.

### BACKGROUND OF THE INVENTION

This invention is related to an illuminated exterior decorative device for vehicles including a decorative part for a vehicle trademark like an emblem, an illuminating part illuminating the decorative part at least partially, and a mounting part attaching the illuminated exterior decorative device to the vehicles.

The automobile is one of the indispensable necessities of modern every-day life. Both manufacturers and consumers of the automobile have felt it desirable to display some visual information somewhere on the surface of the vehicle for the purpose of advertisement and aesthetics since the advent of the era of automobile.

Emblem was one of the solutions to those kinds of needs. An emblem, a pattern used to represent an idea, usually visualizes a logo of manufacturers or a personal penchant. Such emblems have been attached on the front, side, and rear end of vehicle traditionally.

Conventionally, however, the emblems were passive elements in a sense that an external light with a certain minimum luminosity was needed to make the emblems visible. Under the condition of a bright daylight, there exist so many distraction. Especially, during the nighttime, the emblem was totally out of service.

Accordingly, a need for an illuminated exterior decorative device for vehicles was present since the advent of the car. This invention is directed to solve these problems and satisfy the long-felt need.

### SUMMARY OF THE INVENTION

The present invention contrives to solve the disadvantages of the prior art.

An objective of the invention is to provide an illuminated exterior decorative device for vehicles, which maximizes the visibility of an emblem.

Another objective of the invention is to provide an illuminated exterior decorative device for vehicles, which is highly effective under a condition of low luminosity.

Still other objective of the invention is to provide an illuminated exterior decorative device for vehicles, which is easy to attach to a vehicle.

The illuminated exterior decorative device for vehicle includes a decorative part for a vehicle trademark like an emblem, an illuminating part illuminating the decorative part at least partially, and a mounting part attaching the illuminated exterior decorative device to the vehicles.

The decorative part includes a combination of an optically opaque part and an optically transmissive part, using either the optically opaque part or the optically transmissive part to form the pattern of symbol or emblem. The optically transmissive part of the decorative part has a predetermined color.

The illuminating part includes a light source and a light diffusion part and the light source can include one or more electric lamp or LEDs (light-emitting-diodes). The light diffusion part encloses the light source and is made of a colored resin.

The illuminating part illuminates the decorative part from the background, and can further include a controller to control the color, luminance, and on-off interval of the light.

The mounting part includes a double-sided adhesive tape or a mechanical fastener such as a plastic clip and bolts and nuts. The mounting part can also include one or more magnets adapted to predetermined magnetic metal surfaces of the vehicle.

The illuminating part can include some other illuminating means in addition to a regular electric lamp. A fluorescent substance can be used as an illuminating part, in which case the light source of the illuminating part comes from the ambient external light sources. Also, a material with phosphorescence can be used instead of the fluorescent substance.

Many other innovations, features, and advantages will be evident with the following description of the invention.

### BRIEF DESCRIPTION OF THE DRAWINGS

These and other features, aspects and advantages of the present invention will become better understood with reference to the accompanying drawings, wherein:

FIG. 1 is a cross-sectional view of a first embodiment of the invention;

FIG. 2 is a cross-sectional view of a second embodiment of the invention;

FIG. 3 is a cross-sectional view of a third embodiment of the invention;

FIG. 4 is a perspective illustrative view of the invention; and

FIG. 5 is a front elevational view of FIG. 4.

### DETAILED DESCRIPTION OF THE INVENTION

FIG. 1 shows a first embodiment of the invention. An illuminated exterior decorative device 50 for vehicles includes a decorative part 10 for a vehicle trademark like an emblem, an illuminating part 12 illuminating the decorative part 10 at least partially, and a mounting part 14 attaching the illuminated exterior decorative device 50 to the vehicles.

The decorative part 10 includes a combination of an optically opaque part 11 and an optically transmissive part 13, using either the optically opaque part 11 or the optically transmissive part 13 to form the pattern of symbol or emblem. The optically transmissive part 13 of the decorative part 10 can be transparent or have a predetermined color.

The illuminating part 12 includes a light source 17 and a light diffusion part 15 and the light source 17 can include one or more electric lamp or LEDs (light-emitting-diodes). The light diffusion part 15 encloses the light source 17 and is made of a colored resin. The light source 17 can have an electrical wire 32 and a connector 34 as shown in FIG. 5.

The illuminating part 12 illuminates the decorative part 10 from the background, and can further include a controller to control the color, luminance, and on-off interval of the light.

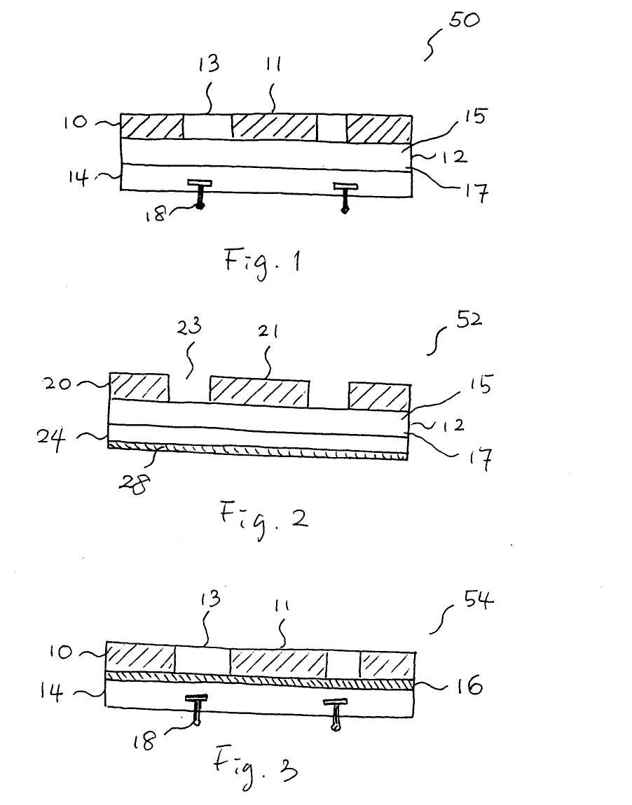

The mounting part 14 includes a mechanical fastener such as a plastic clip 18 and bolts and nuts. Alternatively, the mounting part 24 includes a double-sided adhesive tape 28 as shown in FIG. 2. The mounting part 14 can also include one or more magnets adapted to predetermined magnetic metal surfaces of the vehicle other than the conventionally physically designated places such as the front end, side, and rear end.

FIG. 2 shows a second embodiment of the invention. An illuminated exterior decorative device 52 for vehicles includes a decorative part 20 for a vehicle trademark like an emblem, an illuminating part 12 illuminating the decorative part 20 at least partially, and a mounting part 24 attaching the illuminated exterior decorative device 52 to the vehicles. The decorative part 20 includes an optically opaque part 21. The optically transmissive part 23 corresponding to the part 13 in FIG. 1 is punched out mechanically from the optically opaque part 21.

In FIG. 3, the illuminating part 16 can be made of some other illuminating means instead of a regular electric lamp. A fluorescent substance can be used as an illuminating part 16, in which case the light source of the illuminating part comes from the ambient external light sources. Also, a material with phosphorescence can be used instead of the fluorescent substance.

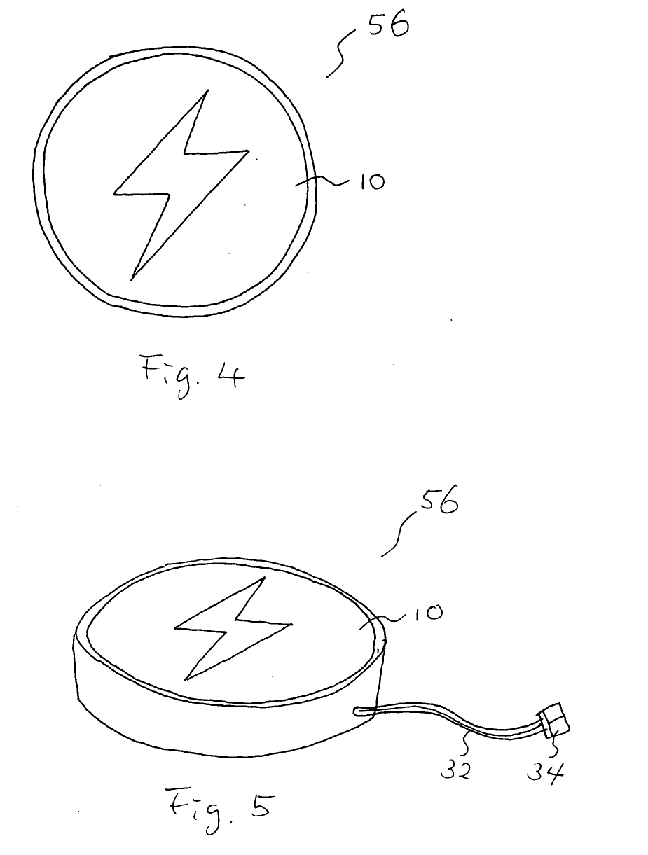

FIG. 4 and FIG. 5 show the perspective views of an embodiment of the invention.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. An illuminated exterior decorative device for vehicles, comprising:
a) a decorative part for a vehicle trademark;
b) an illuminating part illuminating the decorative part at least partially; and
c) a mounting part attaching the illuminated exterior decorative device to the vehicles,
wherein the decorative part comprises a combination of an optically opaque part and an optically transmissive part.

2. The device of claim 1, wherein the optically transmissive part of the decorative part has a predetermined color.

3. The device of claim 1, wherein the illuminating part comprises a light source and a light diffusion part.

4. The device of claim 3, wherein the light source comprises one or more electric lamp.

5. The device of claim 3, wherein the light source comprises one or more light-emitting-diodes.

6. The device of claim 3, wherein the light diffusion part encloses the light source.

7. The device of claim 6, wherein the light source comprises an electric wire and a connector.

8. The device of claim 3, wherein the light diffusion part is made of a colored resin.

9. The device of claim 1, wherein the illuminating part illuminates the decorative part from the background.

10. The device of claim 9, wherein the illuminating part further comprises a controller to control the color and luminance of the light.

11. The device of claim 10, wherein the controller further controls the duration of the illumination.

12. The device of claim 1, wherein the mounting part comprises a double-sided adhesive tape.

13. The device of claim 1, wherein the mounting part comprises a mechanical fastener.

14. The device of claim 1, wherein the mounting part comprises one or more magnets.

15. The device of claim 14, wherein the shape and size of the magnets are adapted to predetermined magnetic metal surfaces of the vehicle.

16. The device of claim 1, wherein the illuminating part comprises fluorescent substance.

17. The device of claim 16, wherein the light source of the illuminating part is illuminated by ambient external light sources.

18. The device of claim 1, wherein the illuminating part comprises a material with phosphorescence.
